(19) United States
(12) Patent Application Publication
(10) Pub. No.: US 2024/0204661 A1
(43) Pub. Date: Jun. 20, 2024

(54) POWER CONVERTER CIRCUITRY

(71) Applicant: Cirrus Logic International Semiconductor Ltd., Edinburgh (GB)

(72) Inventors: Fred CHEN, Oakland, CA (US); Hans MEYVAERT, San Francisco, CA (US); John CROSSLEY, San Francisco, CA (US); Minbok LEE, Seoul (KR)

(73) Assignee: Cirrus Logic International Semiconductor Ltd., Edinburgh (GB)

(21) Appl. No.: 18/084,950

(22) Filed: Dec. 20, 2022

(51) Int. Cl. H02M 3/07; H02M 1/00; H02M 1/08

(52) U.S. Cl. CPC H02M 3/07; H02M 1/0009; H02M 1/08

(57) ABSTRACT

Switched capacitor power converter circuitry comprising: a first converter fragment; a second converter fragment; and control circuitry, wherein the control circuitry is configured to selectively activate the second converter fragment based on an operating parameter indicative of a load current that the switched capacitor power converter circuitry is required to support.

### FIELD OF THE INVENTION

The present disclosure relates to power converter circuitry.

### BACKGROUND

Mobile devices such as laptop and tablet computers typically use battery packs made up of a plurality of individual batteries coupled in series, for example 2S battery packs (comprising two series-connected batteries) or 3S battery packs (comprising three series-connected batteries). Such battery packs can supply relatively high voltages and currents, but individual loads or subsystems (e.g. a processor subsystem, a display subsystem or the like) of the host device typically do not require the full supply voltage available from the battery pack can supply. For example, a typical 3S battery pack for a laptop computer may have a nominal output voltage of between 10.8V and 12.3V, whereas a processor subsystem of the laptop computer may only require a supply voltage of 1V. Power converter circuitry is thus required to step down the supply voltage of the battery pack to a lower voltage that is suitable for a load or subsystem of the host device.

In one approach, as shown in FIG. 1a, a host device 100a may include a battery pack 110 and a separate buck converter (or other inductive converter) 120-1-120-n for each of a plurality of subsystems or loads 130-1-130-n of the host device 100a. Each buck converter 110-1-110-n is configured to step down the battery output voltage VBatt in a single step (e.g. from 10.8V to 1V) to generate a respective supply voltage VSup1-VSupn for the associated subsystem or load 120-1-120-n.

Such converters typically require a large inductor and a large capacitor, which may make them unsuitable for use in small form-factor devices, and may also have high power consumption when waking up from a sleep mode.

In alternative approach, as shown in FIG. 1b, a host device 100b includes a plurality of stages. A first stage includes a buck converter 130 configured to step down the battery output voltage VBatt to an intermediate voltage VInt (e.g. from a battery output voltage VBatt of 10.8V to an intermediate voltage of 3.6V), and a second stage includes separate power management integrated circuitry (implementing, for example, a DC-DC switching regulator) 150-1-150-n for each of a plurality of subsystems or loads 130-1-130-n of the host device 100b. Each instance of power management integrated circuitry is configured to step down the intermediate voltage VInt to a respective lower supply voltage Vsup1-Vsupn required by the associated subsystem or load 130-1-130-n of the of the host device 100b (e.g. from an intermediate voltage VInt of 3.6V to a supply voltage Vsup1 of 1V).

Compared to the buck converter approach described above, this multi-stage approach may improve power efficiency, as the second stage can use a high-efficiency converter. However, each instance of power management integrated circuitry used in the second stage may require one or more inductors, which may lead to increased cost. Additionally the buck converter of the first stage still requires a relatively large inductor.

### SUMMARY

According to a first aspect, the invention provides switched capacitor power converter circuitry comprising:
a first converter fragment;
a second converter fragment; and
control circuitry, wherein the control circuitry is configured to selectively activate the second converter fragment based on an operating parameter indicative of a load current that the switched capacitor power converter circuitry is required to support.

Each of the first converter fragment and the second converter may fragment comprise:
a switch network comprising a plurality of switches;
first contacts for coupling the switch network to a flying capacitor; and
second contacts for coupling the switch network to an output capacitor of the switched capacitor power converter circuitry.

The operating parameter may be a switching frequency of the switch network of the first converter fragment.

The control circuitry may be configured to activate the second converter circuitry if the switching frequency is equal to or less than a first switching frequency threshold.

The first switching frequency threshold may be configured to prevent switching of the switch network(s) at a switching frequency in the audio band.

The first switching frequency threshold may be configured to maintain the switching frequency equal to or greater than 25 kHz.

The control circuitry may be configured to deactivate the second converter circuitry if the switching frequency is equal to or greater than a second switching frequency threshold.

The first converter fragment may be configured to receive a first clock signal for controlling a switching frequency of the switch network of the first converter fragment.

The second converter fragment may be configured to receive a second clock signal for controlling a switching frequency of the switch network of the second converter fragment.

The control circuitry may be configured to disable the second clock signal to deactivate the second converter fragment and to enable the second clock signal to activate the second converter fragment.

The control circuitry may be operative to control a switching frequency of the switch network of the first and/or the second converter fragment based on an output voltage of the power converter circuitry or a ratio of an input voltage to the output voltage of the power converter circuitry.

The control circuitry may be operative to increase the switching frequency if the output voltage of the power converter circuitry meets a first predefined threshold.

The control circuitry may be operative to activate the first converter fragment and the second converter fragment if the output voltage of the power converter circuitry meets or falls below a second predefined threshold.

The control circuitry may be operative to deactivate the second converter fragment if the output voltage of the power converter subsequently exceeds the second predefined threshold and the switching frequency is equal to or less than a second switching frequency threshold.

The control circuitry may be operable to adjust an effective on-resistance of one or more of the plurality of switches of the switch network of the first and/or second converter fragment.

The first converter fragment and the second converter fragment may be coupled in parallel.

The first converter fragment and the second converter fragment may have different switching frequency to output impedance characteristics.

The switched capacitor power converter circuitry may implement a converter stage of a multi-stage power converter architecture.

According to a second aspect, the invention provides an integrated circuit comprising switched capacitor power converter circuitry according to the first aspect.

According to a third aspect, the invention provides a host device comprising switched capacitor power converter circuitry according to the first aspect.

The host device may comprise a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

According to a fourth aspect, the invention provides switched capacitor power converter circuitry comprising:
a plurality of converter fragments; and
control circuitry,
wherein a first converter fragment of the plurality of converter fragments is always active, and wherein the control circuitry is configured to selectively activate or deactivate the other converter fragments of the plurality of converter fragments based on a switching frequency of the first converter fragment.

According to a fifth aspect, the invention provides switched capacitor power converter circuitry for supplying a load, the switched capacitor power converter circuitry comprising a plurality of converter fragments and control circuitry, wherein the control circuitry is configured to activate all of the plurality of converter fragments in response to detection of a load step condition.

According to a sixth aspect, the invention provides switched capacitor power converter circuitry according to claim 21, wherein the control circuitry comprises comparator circuitry configured to compare an output voltage of the switched capacitor power converter circuitry to a load step voltage threshold and to output a signal indicative of detection of a load step condition if the output voltage is equal to or less than the load step threshold voltage.

According to a seventh aspect, the invention provides switched capacitor power converter circuitry comprising a plurality of converter fragments, each converter fragment having a different load current capacity for a given switching frequency, wherein the switched capacitor power converter circuitry is operable to activate one or more of the converter fragments based on a current demand of a load coupled to the switched capacitor power converter circuitry.

According to an eighth second aspect, the invention provides a power converter integrated circuit (IC), for providing a supply voltage to a load, the power converter IC comprising a plurality of separate switched capacitor power converter fragments, each switched capacitor power converter fragment comprising a switch network configured to be coupled to a respective flying capacitor and to a common output capacitor.

The power converter IC according may further comprise control circuitry for controlling operation of the switch networks of the switched capacitor power converter fragments.

The control circuitry may be configured to selectively activate one or more of the plurality of separate switched capacitor power converter fragments based on a switching frequency of an active power converter fragment of the plurality of separate switched capacitor power converter fragments.

The control circuitry may be configured to activate all of the switched capacitor power converter fragments of the plurality of separate switched capacitor power converter fragments in response to a determination that an output voltage of the power converter IC is equal to or less than a load step threshold voltage.

According to a ninth aspect, the invention provides a power converter system for providing a supply voltage to a load, the power converter system comprising:
a primary power converter IC comprising a first plurality of switched capacitor power converter fragments; and
a secondary power converter IC comprising a second plurality of switched capacitor power converter fragments, the secondary power converter IC being coupled to the primary power converter IC,
wherein the primary power converter IC is configured to control operation of the switched capacitor power converter fragments of the primary power converter IC and the secondary power converter IC.

The primary power converter IC may comprise control circuitry operable to selectively activate the switched capacitor converter fragments of the primary and secondary power converter ICs based on a switching frequency of an active switched capacitor converter fragment.

The primary power converter IC may comprise control circuitry operable to active all the switched capacitor converter fragments of the first power converter IC and the second power converter IC in response to a determination that an output voltage of the power converter system is equal to or less than a load step threshold voltage.

According to a tenth aspect, the invention provides a power converter system for providing a supply voltage to a load, the power converter system comprising:
a first power converter IC comprising a first plurality of switched capacitor power converter fragments; and
a second power converter IC comprising a second plurality of switched capacitor power converter fragments, the second power converter IC being coupled to the first power converter IC,
control circuitry configured to control operation of the switched capacitor power converter fragments of the first power converter IC and the second power converter IC.

The control circuitry may be provided in the first and/or second power converter IC. According to an eleventh aspect, the invention provides a power converter system comprising:
a first converter stage configured to receive a supply voltage and output an intermediate voltage; and
a second converter stage configured to receive the intermediate voltage and output a final supply voltage for supplying a load,
wherein the first converter stage or the second converter stage comprises:
   switched capacitor converter circuitry comprising:
      a first converter fragment;
      a second converter fragment; and
      control circuitry configured to selectively activate the first and second converter fragments based on an operating parameter indicative of a load current that the power converter system is required to support.

### BRIEF DESCRIPTION OF THE DRAWINGS

Embodiments of the invention will now be described, strictly by way of example only, with reference to the accompanying drawings, of which:

FIG. 1a is a diagrammatic representation of one approach to providing suitable supply voltages for subsystems or loads of a host device;

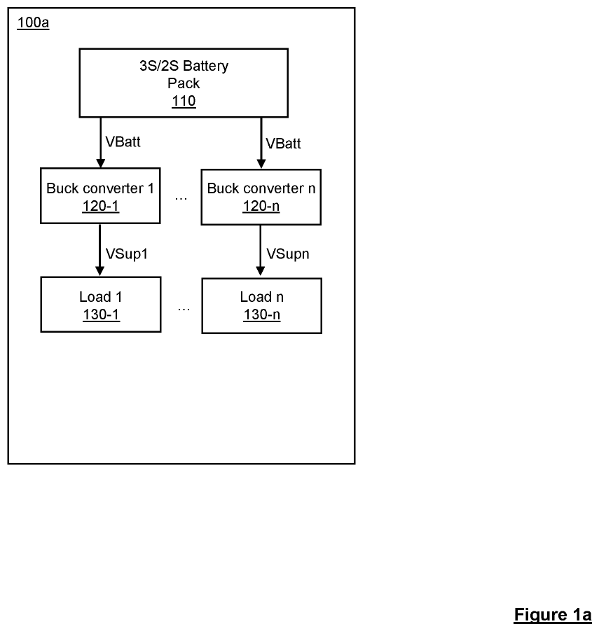

FIG. 1b is a diagrammatic representation of an alternative approach to providing suitable supply voltages for subsystems or loads of a host device;

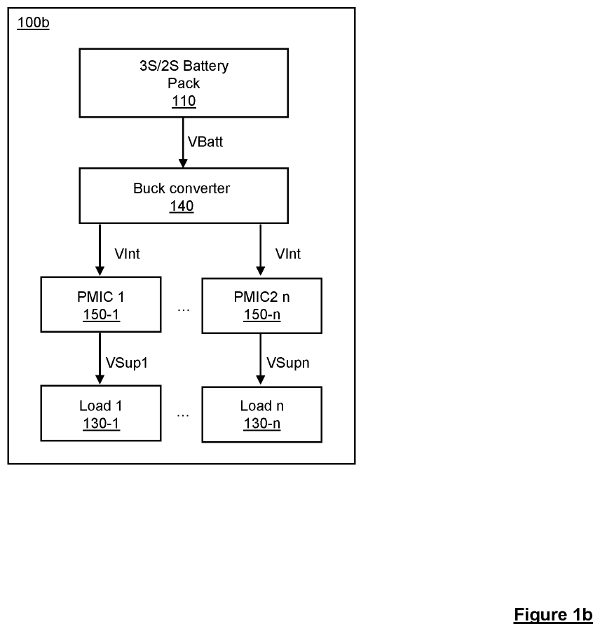

FIG. 2 is a diagrammatic representation of a further alternative approach to providing suitable supply voltages for subsystems or loads of a host device;

FIG. 3 is a schematic representation of switched-capacitor DC-DC converter circuitry;

FIG. 4 shows a relationship between a switching frequency and an output impedance in the switched-capacitor DC-DC converter circuitry of FIG. 3;

FIG. 5 is a schematic representation of power converter circuitry according to the present disclosure;

FIG. 6 is a shows relationships between a switching frequency and an output impedance for converter fragments in the power converter circuitry of FIG. 5;

FIG. 7 is a schematic representation of example circuitry for selectively activating converter fragments of the power converter circuitry of FIG. 5; and

FIG. 8 is a diagrammatic representation of a power converter system comprising a plurality of separate instances of power converter circuitry coupled together for providing an output voltage VOUT to a load.

### DETAILED DESCRIPTION

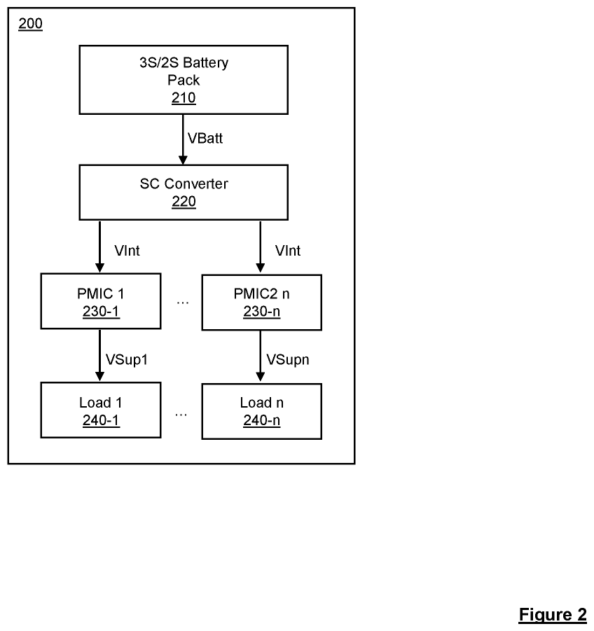

FIG. 2 is a diagrammatic representation of further alternative approach to providing suitable supply voltages for subsystems or loads of a host device. In this approach a host device 200 includes a battery pack 210 (e.g. a 2S or 3S battery pack) and power conversion architecture comprising a plurality of stages for stepping down the output voltage of the battery pack 210 to supply voltages suitable for a plurality of subsystems or loads of the host device 200.

A first stage includes a switched-capacitor converter 220 configured to step down the battery output voltage VBatt to an intermediate voltage VInt (e.g. from a battery output voltage VBatt of 10.8V to an intermediate voltage of 3.6V), and a second stage includes separate power management integrated circuitry (implementing, for example, a DC-DC switching regulator) 230-1-230-n for each of a plurality of subsystems or loads 240-1-240-n of the host device 200. Each instance of power management integrated circuitry is configured to step down the intermediate voltage VInt to a respective lower final supply voltage Vsup1-Vsupn required by the associated subsystem or load 240-1-240-n of the of the host device 100b (e.g. from an intermediate voltage VInt of 3.6V to a supply voltage Vsup1 of 1.2V).

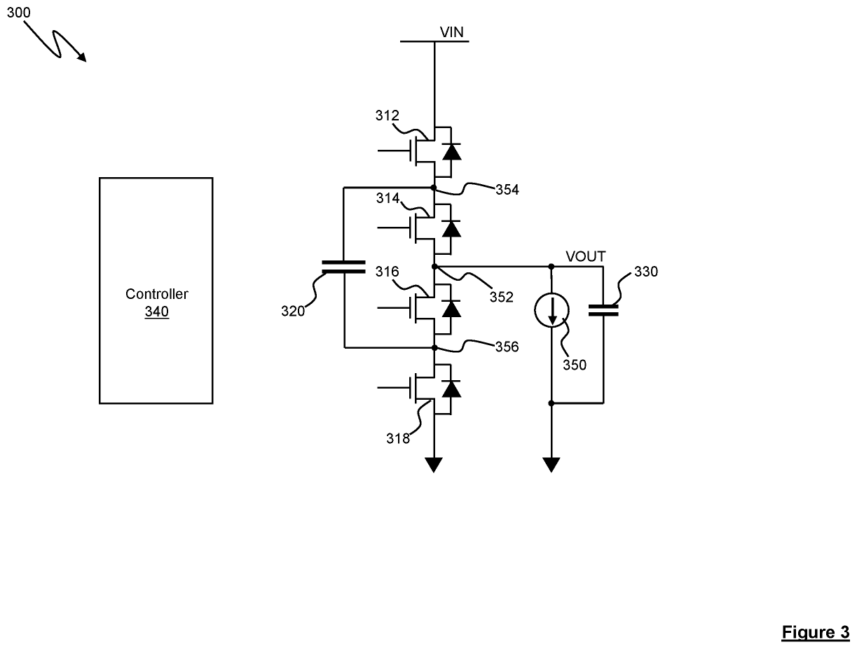

FIG. 3 is a schematic representation of an example switched-capacitor converter. As shown generally at 300, the switched capacitor converter in this example comprises a switch network including first to fourth switches 312-318, a flying capacitor 320, an output capacitor 330 and controller circuitry 340.

The first and second switches 312, 314 (which in this example are MOSFET devices) are coupled in series between an input voltage supply rail VIN and a first node 352, and the third and fourth switches 316, 318 (which in this example are also MOSFET devices) are coupled in series between the first node 352 and a ground (or other reference voltage) supply rail.

The flying capacitor 320 is coupled between a second node 354 and a third node 356. The second node is between the first and second switches 312, 314 and the third node is between the third and fourth switches 312, 314.

The output capacitor 330 is coupled between the first node 352 and the ground (or other reference voltage) supply rail.

In operation of the switched-capacitor converter 300, the controller circuitry 340 supplies control signals at a switching frequency F_{SW} to control terminals (e.g. gate terminals, in this example) of the switches 312-318, to cause the flying capacitor 320 to be coupled either to the input supply voltage rail VIN or in parallel with the output capacitor 330. An output voltage VOUT supplied to a load 350 is dependent upon the input voltage, switching frequency F_{SW} and the capacitances of the flying capacitor 320 and the output capacitor 330.

The switched-capacitor converter 300 of FIG. 3 can be modelled as an ideal transformer with an output impedance R_{OUT}. The output impedance R_{OUT} is a function of the switching frequency F_{SW}, the size of the flying capacitor 320 and the output capacitor 330 and the size of the switches 312-318.

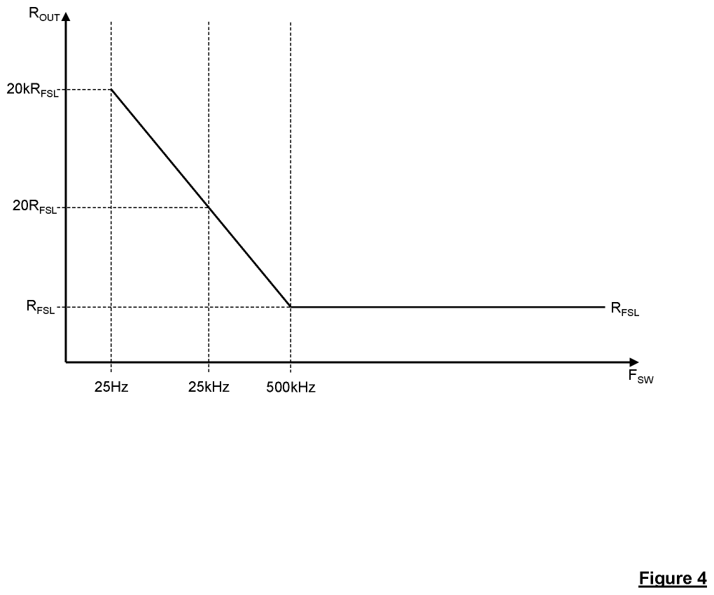

FIG. 4 shows the relationship between the output impedance R_{OUT} and the switching frequency F_{SW} in the switched-capacitor converter 300. As can be seen in FIG. 4, above an upper switching frequency threshold (which in this example is 500 kHz), the output impedance R_{OUT} has a constant value R_{FSL}. At switching frequencies below the upper switching frequency threshold, the output impedance R_{OUT} decreases as the switching frequency F_{SW} increases. In this example, at a switching frequency F_{SW} of 25 Hz, the output impedance R_{OUT} is equal to 20 kR_{FSL}, whereas at a switching frequency F_{SW} of 25 kHz the output impedance R_{OUT} is equal to 20R_{FSL}. The output impedance R_{OUT} continues to decrease as the switching frequency F_{SW} increases, until the upper switching frequency is reached, after which the output impedance stays constant at R_{FSL} as the switching frequency F_{SW} increases.

Switched-capacitor converters are very efficient at delivering integer ratioed conversions (e.g. 2:1, 3:1, 3:2 etc.) with fast transient responses, and thus are well suited to use in the first stage of the multi-stage the step-down conversion arrangement of FIG. 2.

In some implementations, the capacitors 320, 330 of the switched-capacitor converter 300 are ceramic capacitors. In such implementations, during each switching event, a mechanical resonance of these ceramic capacitors can be excited. If the switching frequency of the switched-capacitor converter 300 is in the audible band (20 Hz-20 kHZ), the mechanical resonance of the capacitors will generate audible noise.

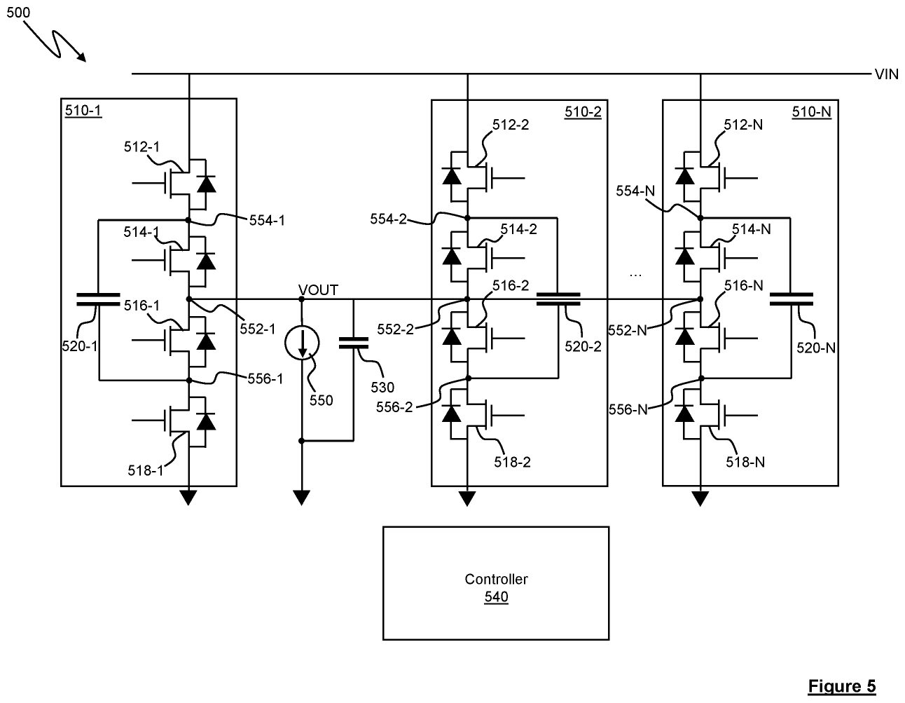

As will be appreciated, such audible noise is generally undesirable. One option for avoiding audible noise is to limit the switching frequency F_{SW} to frequencies above the audible range, e.g. by limiting the switching frequency F_{SW} to frequencies equal to or greater than 25 kHz. However, limiting the switching frequency F_{SW} in this way also limits the dynamic range of the output impedance R_{OUT}. In the example illustrated in FIG. 5, limiting the switching frequency F_{SW} to frequencies equal to or greater than 25 kHz limits the dynamic range of the output impedance R_{OUT} to 10× (as the output impedance at a switching frequency of 25 kHz is 20R_{FSL}, while at switching frequencies of 500 kHz and above the output impedance is R_{FSL}). However, in some applications the dynamic range of the current drawn by a load in can be almost four orders of magnitude (e.g. from a minimum load current of 10 mA to a maximum load current of 100 A).

At high load currents the restriction of the switching frequency to avoid generating audible noise is not a problem, but at lower load currents the converter becomes less efficient as the load current decreases. As the converter has to switch at an artificially high switching frequency (i.e. a higher switching frequency than is required to support the load current) to avoid generating audible noise, losses associated with switching the converter (e.g. gate switching loss and parasitic drain loss) that do not scale with the load current are proportionally higher than at higher load currents, leading to reduced efficiency.

One approach to improving efficiency is to reduce the switch size at lower switching frequencies, by turning on only a fraction of the switches used to actively switch the capacitors. This approach gives rise to modest improvements in converter efficiency, but does not reduce losses due to parasitic drain capacitances, which are still connected even when the switch size is reduced in this way. Thus, the converter efficiency may not be sufficient to meet the requirements of particular applications even when this approach is adopted.

FIG. 5 is a schematic representation of power converter circuitry according to the present disclosure. The power converter circuitry, shown generally at 500 in FIG. 5, is particularly suited to use in place of the switched-capacitor converter 220 in the first stage of the power conversion architecture of the host device 200 shown in FIG. 2. The power converter circuitry 500 may also be used in place of one or more of the instances of power management integrated circuitry 230-1-230-n in the second stage of the power conversion architecture of the host device 200 shown in FIG. 2.

The power converter circuitry 500 includes a plurality (in this example three) of differently-sized parallel instances 510-1-510-N of converter circuitry (hereinafter referred to as “converter fragments”), an output capacitor 530, which is common to all the converter fragments 510-1-510-N and control circuitry 540, which in this example is also common to all the converter fragments 510-1-510-N. In other examples each converter fragment 510-1-510-N may be associated with its own control circuitry.

In this example each converter fragment 510-1-510-N comprises a separate instance of switched capacitor converter circuitry, but other possible implementations may use different converter topologies for some or all of the converter fragments 510-1-510-N. For example, in some implementations each converter fragment 510-1-510-N may comprise a separate instance of inductive converter circuitry (e.g. buck converter circuitry), or may comprise a separate instance of hybrid capacitive-inductive converter circuitry. Other implementations may adopt a mixed-topology approach in which one or more of the converter fragments 510-1-510-N are instances of switched capacitor converter circuitry, and one or more of the converter fragments 510-1-510-N are instances of some other type of converter circuitry, e.g. inductive converter circuitry or hybrid capacitive-inductive converter circuitry.

For the sake of clarity and brevity, implementations of the power converter circuitry 500 in which any the converter fragments 510-1-510-N includes a switched capacitor stage or switched capacitors will be referred to herein as “switched capacitor power converter circuitry”. Thus, the term “switched capacitor power converter circuitry” as used herein is intended to encompass implementations of the power converter circuitry 500 in which one or more of the converter fragments 510-1-510-N comprises switched capacitor or hybrid capacitive-inductive converter circuitry, regardless of the topology of any of the other converter fragments 510-1-510-N.

Each converter fragment 510-1-510-N in the example of FIG. 5 is an instance of switched capacitor converter circuitry, and includes a respective switch network and a respective flying capacitor. Thus, a first converter fragment 510-1 comprises a switch network including first to fourth switches 512-1-518-1 and a flying capacitor 520-1.

The first and second switches 512-1, 514-1 (which in this example are MOSFET devices) are coupled in series between an input voltage supply rail VIN and a first node 552-1, and the third and fourth switches 516-1, 518-1 (which in this example are also MOSFET devices) are coupled in series between the first node 552-1 and a ground (or other reference voltage) supply rail.

The flying capacitor 520-1 is coupled between a second node 554-1 and a third node 556-1. The second node 554-1 is between the first and second switches 512-1, 514-1 and the third node 556-1 is between the third and fourth switches 512-1, 514-1.

A first terminal of the common output capacitor 530 is coupled to the first node 552-1 and a second terminal of the common output capacitor 530 is coupled to the ground (or other reference voltage) supply rail. Thus the first node 552-1 may be considered an output node of the first converter fragment 510-1.

A second converter fragment 510-2 comprises a switch network including first to fourth switches 512-2-512-8 and a flying capacitor 520-2 coupled in the same configuration as in the first converter fragment 510-1, with a first node 552-2 between the second and third switches 514-2 and 516-2 (also referred to as an output node of the second converter fragment 510-2) being coupled to the first terminal of the common output capacitor 530.

Similarly, an Nth (in this example third) converter fragment 510-N comprises a switch network including first to fourth switches 512-N-512-N and a flying capacitor 520-N coupled in the same configuration as in the first converter fragment 510-1, with a first node 552-N between the second and third switches 514-N and 516-N (also referred to as an output node of the third converter fragment 510-N) being coupled to the first terminal of the common output capacitor 530.

The converter fragments are differently sized in the sense that their switches may be differently-sized, and/or their flying capacitors may have different capacitances. For example, the flying capacitor 520-1 of the first converter fragment 510-1 may be implemented as a first bank comprising a first plurality of capacitors coupled in parallel to achieve a first capacitance, while the flying capacitor 520-2 of the second converter fragment 510-2 may be implemented as a second bank comprising a second plurality of capacitors coupled in parallel to achieve a second capacitance which is lower than the first capacitance, and the flying capacitor 520-N of the Nth converter fragment 510-N may be a single capacitor of a third capacitance which is lower than the first and second capacitances.

The first converter fragment 510-1 may thus be regarded as a “large fragment”, the second converter fragment 510-2 may be regarded as a “medium sized fragment” and the Nth converter fragment 510-N may be regarded as a “small fragment”.

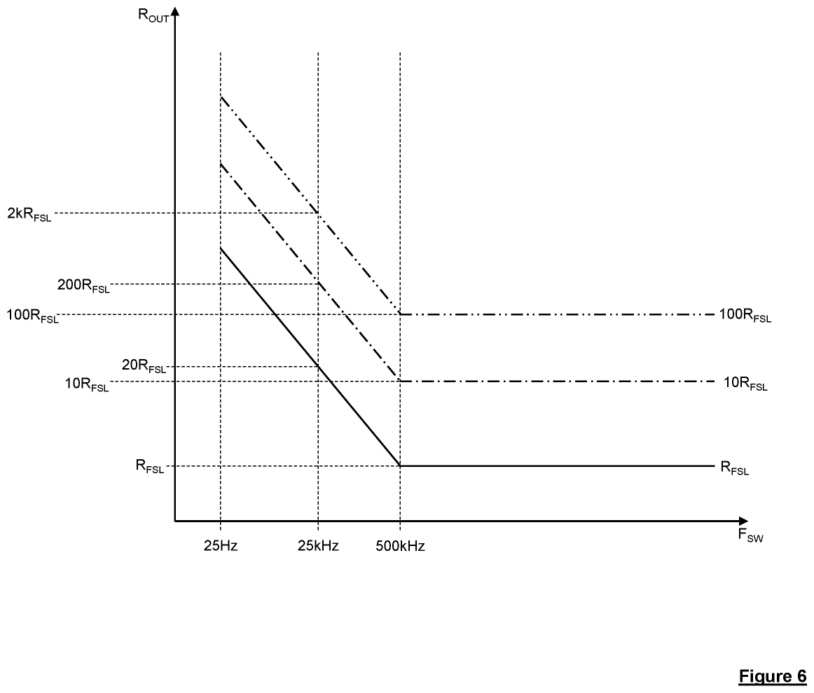

Each of the converter fragments N has a different switching frequency/output impedance characteristic, as shown in FIG. 6.

The lowermost trace 610 in FIG. 6 shows the switching frequency/output impedance characteristic of the first converter fragment 510-1, from which it can be seen that in this example the output impedance R_{OUT} of the first converter fragment 510-1 at a switching frequency of 25 kHz is 20R_{FSL}, and decreases with increasing switching frequency to a minimum of R_{FSL} at a switching frequency of 500 kHz. At switching frequencies above 500 kHz the output impedance R_{OUT} of the first converter fragment 510-1 remains at R_{FSL}.

The middle trace 620 in FIG. 6 shows the switching frequency/output impedance characteristic of the second converter fragment 510-2, from which it can be seen that in this example the output impedance R_{OUT} of the second converter fragment 510-2 at a switching frequency of 25 kHz is 200R_{FSL}, and decreases with increasing switching frequency to a minimum of 10R_{FSL} at a switching frequency of 500 kHz. At switching frequencies above 500 kHz the output impedance R_{OUT} of the second converter fragment 510-2 remains at 10R_{FSL}.

The uppermost trace 630 in FIG. 6 shows the switching frequency/output impedance characteristic of the Nth converter fragment 510-N, from which it can be seen that in this example the output impedance R_{OUT} of the Nth converter fragment 510-N at a switching frequency of 25 kHz is 20 kR_{FSL}, and decreases with increasing switching frequency to a minimum of 100R_{FSL} at a switching frequency of 500 kHz. At switching frequencies above 500 kHz the output impedance R_{OUT} of the Nth converter fragment 510-N remains at 10R_{FSL}.

In operation of the power converter circuitry 500, the control circuitry 540 selectively activates the plurality of converter fragments 510-1-510-N based on the load current that the power converter circuitry 500 is required to support, to generate an output voltage VOUT to supply to a load 550. Only those converter fragments 510-1-510-N that are required to support a prevailing or expected load current are activated. For example, where the load current is small (e.g. when a host device that incorporates the power converter circuitry is in a sleep mode), only the Nth (smallest) converter fragment 510-N may be activated by the control circuitry 540, whereas for higher load currents all of the converter fragments 510-1-510-N may be activated, and for intermediate load currents only the first and second converter fragments 510-1 and 510-2 may be activated. Because all the converter fragments 510-1-510-N are coupled in parallel, with only DC nodes being shared, losses associated with switching are minimised. Thus, selectively activating the converter fragments 510-1-510-N in this way allows a range of load currents to be supported with high efficiency without using switching frequencies in the audio band, thus preventing audible noise.

The power converter circuitry 500 may be implemented in integrated circuitry, e.g. as one or more integrated circuits (ICs). In an integrated circuit implementation of the power converter circuitry 500, the switches 512-1-518-N, control circuitry 540, flying capacitors 520-1-520-N, and output capacitor 530 may be implemented in integrated circuitry (i.e. may be on-chip components).

Alternatively, the flying capacitors 520-1-520-N and output capacitor 530 may be external to integrated circuitry that implements the switches 512-1-518-N and control circuitry 540 (i.e. the flying capacitors 520-1-520-N and output capacitor 530 may be off-chip components), with the integrated circuitry including contacts for coupling each of the switch networks of the converter fragments 510-1-510-N to a respective off-chip flying capacitor 520-1-520-N and to an off-chip common output capacitor 530.

Thus, in such an implementation, a power converter IC may comprise a plurality of separate power converter fragments, each power converter fragment comprising a switch network configured to be coupled to a respective flying capacitor and to a common output capacitor.

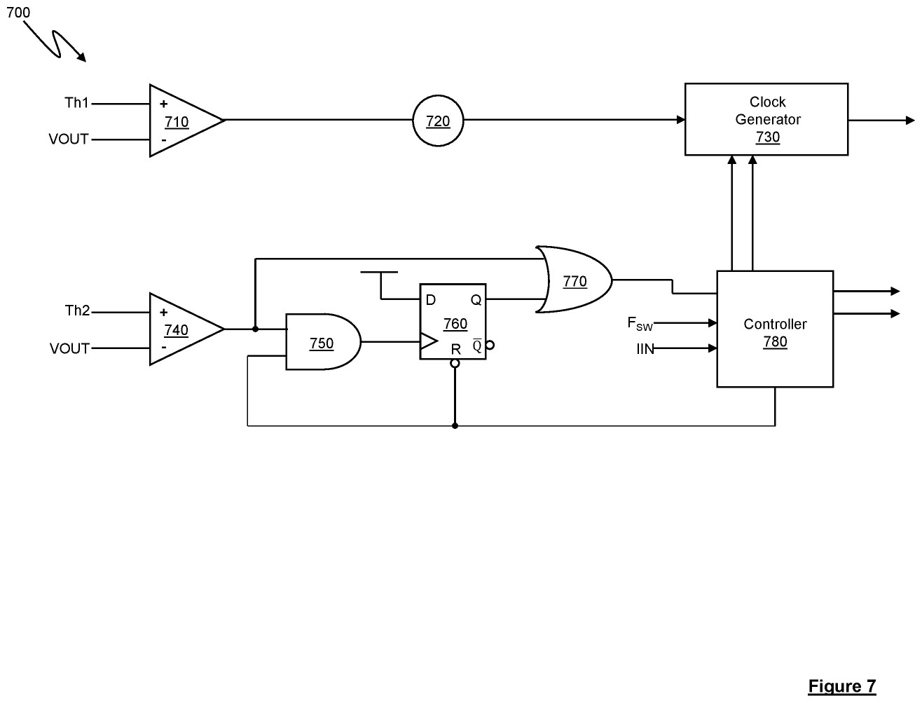

FIG. 7 is a schematic representation of example circuitry for selectively activating the converter fragments 510-1-510-N. The illustrated circuitry may be implemented, for example, by the control circuitry 540 of the power converter circuitry 500.

The circuitry of FIG. 7 implements a first control method which selectively activates the converter fragments 510-1-510-N based on a switching frequency F_{SW} of the currently active converter fragment(s) (which provides an indication of a load current) and a second control method which controls the switching frequency F_{SW} of the active converter fragment(s) 510-1-510-N based on the output voltage VOUT, and activates all the converter fragments 510-1-510-N on detection of a load step condition.

The circuitry, shown generally at 700 in FIG. 7, includes first comparator circuitry 710 having a non-inverting (+) input at which a first threshold signal Th1 is received, and an inverting (−) input which is coupled to the first terminal of the output capacitor 530 of the power converter circuitry 500 of FIG. 5, so as to receive the output voltage VOUT of the power converter circuitry 500.

An output of the first comparator circuitry 710 is coupled to a control input of signal generator circuitry 720. The signal generator circuitry 720 may be, for example, oscillator circuitry, and is configured to generate an oscillating output signal, the frequency of which can be varied according to an output signal of the first comparator circuitry 710.

An output of the signal generator circuitry 720 is coupled to an input of clock generator circuitry 730. The clock generator circuitry 730 is configured to generate and output clock signals to control the switching frequency for all the converter fragments 510-1-510-3, based on the oscillating output signal output by the signal generator circuitry 720.

The first comparator circuitry 710, signal generator circuitry 720, and clock generator circuitry 730 are operable to control the switching frequency of active converter fragments of the plurality of converter fragments 510-1-510-3. The output voltage VOUT of the power converter circuitry 500 is indicative of the current drawn by the load 550. As the load current increases, the output voltage VOUT decreases, until it reaches a level at which the active converter fragment(s) of the power converter circuitry 500 cannot support the load current at the prevailing switching frequency and so the switching frequency should be increased.

Thus, the first comparator circuitry 710 is operative to compare the output voltage VOUT to the first threshold signal Th1. While the output voltage VOUT is greater than a voltage magnitude of the first threshold signal Th1, the output of the first comparator circuitry 710 remains low. When the output voltage VOUT is equal to or lower than the voltage magnitude of the first threshold signal Th1, the output of the first comparator circuitry 710 goes high. This causes the signal generator circuitry 720 to increase the frequency of its oscillating output signal, which in turn increases the frequency of the clock signal that is output by the clock generator circuitry 730 to control the switching frequency of the active converter fragments.

The circuitry 700 further includes second comparator circuitry 740 having a non-inverting (+) input, at which a second threshold signal Th2 (also referred to as a load step threshold voltage) is received, and an inverting (−) input, which is coupled to the first terminal of the output capacitor 530 of the power converter circuitry 500 of FIG. 5 so as to receive the output voltage VOUT of the power converter circuitry 500.

An output of the second comparator circuitry 740 is coupled to a first input of an AND gate 750, and an output of the AND gate 750 is coupled to a clock input of a D-type flip-flop 760. A D input of the D-type flip-flop is coupled to a logic level 1 or high reference voltage source. A Q output of the D type flip flop is coupled to a first input of an OR gate 770, which has a second input coupled to the output of the second comparator circuitry 740. An output of the OR gate 770 is coupled to an input of a controller 780.

The second comparator circuitry 740 and the OR gate 770 are operable to activate all the converter fragments 510-1-510-3 in response to a step increase in a load current that the power converter circuitry 500 is required to support.

The second comparator circuitry 740 is operative to compare the output voltage VOUT to the second threshold signal Th2.

While the output voltage VOUT is greater than a voltage magnitude of the second threshold signal Th2, which is lower than that of the first threshold signal Th1, the output of the second comparator circuitry 740 remains low.

When the output voltage VOUT is equal to or lower than the voltage magnitude of the second threshold signal Th2, the output of the second comparator circuitry 740 goes high, causing the output of the OR gate 770 to go high, which in turn causes the controller 780 to output control signals to the clock generator circuitry 730 to activate all the converter fragments 510-1-510-3 (as will be explained in more detail below).

Activating all the converter fragments 510-1-510-3 if the output voltage VOUT drops to (or below) the second threshold ensures that the power converter circuitry 500 is able to respond rapidly to a step increase in load current, such that the power converter circuitry 500 can support a sudden increase in load current with minimum delay.

Once the load current has stabilised to a steady state (e.g. when any transient effects have subsided) after the step increase, converter fragments that are not required to support the steady-state load current can be deactivated, as will be explained in more detail below.

The AND gate 750, D-type flip-flop 760, OR gate 770 and controller 780 are operable to selective activate the converter fragments 510-1-510-3 based on the switching frequency of an active converter fragment when the load current is changing slowly, e.g. in normal operation of the power converter circuitry 500 or when the load current has stabilised following a step increase.

To this end, the controller 780 is configured to receive a signal indicative of the switching frequency F_{SW} of the active converter fragment(s). A reset output of the controller 780 is coupled to an active low reset input of the D-type flip-flop 760 and to a second input of the AND gate 740.

As will be apparent from FIGS. 4 and 6, the higher the load current, the lower the output impedance R_{OUT} of the power converter circuitry must be and thus the higher the switching frequency F_{SW} of the active converter fragment(s) must be. Thus, the switching frequency F_{SW} of the active converter fragment(s) can be used by the controller 780 as a proxy for load current. When the load current has stabilised or reached a steady state after a step increase in load current, or when the load current is changing slowly, the switching frequency F_{SW} of the active converter fragment(s) is constant or changing slowly.

In normal operation of the circuitry 700 (i.e. when no step increase in load current has occurred or after the load current has stabilised following a load step), the reset output of the controller 780 is held low, such that the Q output of the D-type flip-flop 760 is also low. As long as the output voltage VOUT is greater than the second threshold Th2, the output of the second comparator circuitry 740 is low and thus the output of the OR gate 770 is also low. The controller 780 interprets the low signal at its input as an indication that it need not keep all the converter fragments active, but may deactivate some of the converter fragments to reduce power consumption and increase efficiency. Thus, when the load current has stabilised to a steady state following a load step, the controller 780 may output control signals to the clock generator circuitry 730 to deactivate or “pause” some of the converter fragments 510-1-510-N, provided the output voltage VOUT has returned to a level greater than the second threshold Th2.

In the example discussed above, the output voltage VOUT is compared to a first threshold to determine whether the switching frequency of the active converter fragment should be increased. In other examples the switching frequency of the active converter fragment could be controlled based on a ratio of the input voltage VIN to the output voltage VOUT. In such examples the first comparator circuitry 710 may be operative to compare an input voltage/output voltage ratio VIN:VOUT to the first threshold signal Th1 (which is suitably adapted) and to control the signal generator circuitry 720 based on the result of this comparison as described above.

Similarly, in some examples, instead of comparing the output voltage VOUT to the second threshold signal Th2 to determine whether all the converter fragments 510-1-510-N should be activated in response to a load current step, the ratio VIN:VOUT may be compared by the second comparator circuit 740 to the second threshold signal Th2 (which is again suitably adapted), and the result of this comparison may be used to trigger activation of all the converter fragments 510-1-510-N as described above.

To determine which of the converter fragments 510-1-510-N can be deactivated or paused following a step increase in load current, the controller 780 compares the switching frequency F_{SW} of the active converters to a plurality of switching frequency thresholds. For power converter circuitry 500 as shown in FIG. 5 having three converter fragments 510-1-510-N, the controller 780 may be operative to compare the switching frequency F_{SW} to first, second and third progressively lower switching frequency thresholds.

If the switching frequency F_{SW} is equal to or greater than an upper switching frequency threshold ThSwUpper, this may be indicative that although the load current has stabilised, all the converter fragments 510-1-510-N need to remain active to support the load current, and thus the controller 780 continues to output control signals to the clock generator circuitry 730 to maintain all the converter fragments 510-1-510-N in an active state.

If the switching frequency F_{SW} is lower than the upper switching frequency threshold ThSwUpper but greater than or equal to an intermediate switching frequency threshold ThSwInt, this may be indicative that the first converter fragment 510-1 is not required to support the load current and thus can be deactivated or paused. The controller 780 thus outputs control signals to the clock generator circuitry 730 to maintain the second and third converter fragments 510-2, 510-3 in an active state and to deactivate or pause the first controller fragment 510-1.

If the switching frequency F_{SW} is lower than the intermediate switching frequency threshold ThSwInt but greater than or equal to a lower switching frequency threshold ThSwLower, this may be indicative that the first and second converter fragments 510-1, 510-2 are not required to support the load current and thus can be deactivated or paused.

The controller 780 thus outputs control signals to the clock generator circuitry 730 to maintain the third converter fragment 510-3 in an active state and to deactivate or pause the first and second controller fragments 510-1, 510-2.

The lower switching frequency threshold ThSwLower is selected or configured to prevent the switches of the active converter fragments from switching at a switching frequency in the audio band, which could give rise to audible noise as a result of exciting mechanical resonances of the flying capacitors 520-1-520-3 and/or the output capacitor 530 as discussed above. For example, the lower switching frequency threshold ThSwLower may be 25 kHz, or may be selected or configured to maintain the switching frequency at or above 25 kHz, to prevent switching in the audio band.

Thus, the power converter circuitry 500 can return to a more efficient operating state following a step increase in the load current by selectively deactivating those converter fragments 510-1-510-3 that are not required to support the steady state load current.

The controller 780 is similarly operative to compare the switching frequency F_{SW} of active converter fragment(s) to the plurality of switching frequency thresholds during normal operation of the power converter circuitry 500.

Thus, if the power converter circuitry 500 is operating with only the third converter fragment 510-3 active, and the switching frequency F_{SW} increases above the intermediate switching frequency threshold ThSwInt, this may be indicative that the third converter fragment 510-3 is unable to support the load current, and so the controller 780 may output control signals to maintain the third converter fragment 510-3 in an active state and to activate the second converter fragment 510-2.

Similarly, if the power converter circuitry 500 is operating with the second and third converter fragments 510-2, 510-3 active and the switching frequency F_{SW} increases above the upper switching frequency threshold ThSwUpper, this may be indicative that the combination of the second and third converter fragments 510-2, 510-3 is unable to support the load current, and so the controller 780 may output control signals to maintain the second and third converter fragments 510-2, 510-3 in an active state and to activate the first converter fragment 510-1.

If the switching frequency F_{SW} subsequently drops below the upper switching frequency threshold ThSwUpper or the intermediate switching frequency threshold ThSwInt, the first and second converter fragments 510-1, 510-2 may be deactivated or paused as described above.

In some examples the switching frequency thresholds to which the controller 780 compares the switching frequency F_{SW} are different when the current is increasing than when the load current is decreasing. When the load current is increasing, the controller 780 may compare the switching frequency F_{SW} to first intermediate and upper switching frequency thresholds ThSwInt1, ThSwUpper1, and when the load current is decreasing, the controller 780 may compare the switching frequency F_{SW} to second intermediate and upper switching frequency thresholds ThSwInt2, ThSwUpper2, where ThSwInt2 is lower than ThSwInt1 and ThSwUpper2 is lower than ThSwUpper2. This provides a degree of hysteresis to prevent “hunting”, i.e. continuous activation a deactivation of converter fragments 510-1-510-2 in response to changes in switching frequency that arise as a result of the activation or deactivation of a converter fragment.

In the example discussed above the controller 780 is operative to compare the switching frequency to three switching frequency thresholds, corresponding to the three converter fragments of the power converter circuitry 500 of FIG. 5. As will be appreciated by those of ordinary skill in the art, in power converter circuitry having more than three converter fragments, there will be more than three switching frequency thresholds, and in power converter circuitry with two converter fragments there will only be two switching frequency thresholds.

In order to allow converter fragments to be activated quickly to support a step increase in load current as described above, it is beneficial to “pause” any inactive converter fragment rather than shutting it down completely (e.g. by decoupling it from a power supply). This can be achieved by placing the inactive converter fragment in an operating condition in which any bootstrap capacitors associated with the converter fragment are maintained at the correct voltage for active operation of the converter fragment, and any auxiliary supply rails associated with the converter fragment are charged to a required level for active operation of the converter fragment.

To this end, each of the plurality of converter fragments 510-1-510-N may receive a respective clock signal, for controlling the switching frequency of the switches 512-518, derived from a main clock signal. For example, the clock generator circuitry 730 may be configured to generate the main clock signal based on the oscillating output signal output by the signal generator circuitry 720, and to generate first to Nth derivative clock signals CLK-1-CLK-N, based on the main clock signal, for output to the first to Nth converter fragments 510-1-510-N to control the switching frequency of the switches of the converter fragments 510-1-510-N.

To pause a particular converter fragment, the clock generator circuitry 730 may disable the derivative clock signal output to the particular converter fragment. To subsequently re-activate the converter fragment, the clock generator circuitry 730 may enable the relevant derivative clock signal.

For example, to pause the first converter fragment 510-1 (e.g. when the load current has returned to a steady state following a step increase), the clock generator circuitry 730 may disable the relevant derivative clock signal CLK-1 in response to a control signal output to the clock generator circuitry 730 by the controller 780. As the switches 512-1-518-1 now receive no clock signal, they stop switching, effectively deactivating the first converter fragment 510-1. However, circuitry (external to the first converter fragment 51001) that maintains the voltage of any bootstrap capacitors and the voltage of any auxiliary supply rails associated with the first converter fragment 510-1 continues to operate, thereby maintaining the voltage of any such bootstrap capacitors and auxiliary supply rails at the correct level to permit a rapid transition to active operation of the first converter fragment 510-1.

To re-activate the first converter fragment 510-1 after it has been paused, the clock generator circuitry 730 may enable the relevant derivative clock signal CLK-1, such that the switches 512-1-518-1 of the first converter fragment 510-1 can start switching again.

The clock generator circuitry 730 may include control circuitry (e.g. logic circuitry) to allow each derivative clock signal CLK-1-CLK-N to be enabled asynchronously (i.e. not in synchronisation with a pulse of the main clock signal) without glitching.

In the example described above with reference to FIG. 7, the converter fragments 510-1-510-N are selectively activated or deactivated based on the switching frequency F_{SW} of the active converter fragment(s).

However, the converter fragments 510-1-510-N could be selectively activated or deactivated based on other operating parameters of the power converter circuitry 500, instead of or addition to the switching frequency F_{SW}. For example, an input current to the power converter circuitry 500 and/or an output current from the power converter circuitry could be monitored (e.g. by the controller), and the converter fragments 510-1-510-N could be selectively activated or deactivated based on a comparison of the input and/or output current to one or more thresholds.

As well as selectively activating and deactivating the converter fragments 510-1-510-N to support a required load current, the present disclosure also contemplates extending the range of load currents that can be supported by an active converter fragment 510-1-510-N. In some examples, an effective on-resistance of one or more of the switches 512-518 of an active converter fragment 510-1-510-N can be modulated to adjust the output impedance R_{OUT} of the power converter circuitry 500, thus varying the range of load currents that can be supported by the active converter fragment 510-1-510-N. In such examples, the controller 780 may control the on-resistance of the switch(es) by adjusting a gate-source voltage applied to the switch(es) to turn them on, based on an operating parameter of the power converter circuitry 500, e.g. a switching frequency, input current or output current.

As noted above, the load current that can be supported by the power converter circuitry 500 is a function of the output impedance R_{OUT} of the power converter circuitry 500. A target output impedance of the power converter circuitry is dictated indirectly by an output voltage drop relative to an ideal conversion ratio of the power converter circuitry 500, which typically has predefined fixed value. If, instead of using a predefined fixed value for the output voltage drop, this voltage drop is modulated, e.g. by the control circuitry 540, the load current range that can be supported by a converter fragment 510-1-510-N can be varied. Thus, in some examples the controller 540 may be configured to modulate the output voltage drop to vary a target output impedance of one or more of the converter fragments 510-1-510-N, so as to vary the load current range that can be supported by the one or more converter fragments 510-1-510-N.

In the examples described above a single instance of the power converter circuitry 500 (which may be implemented as an integrated circuit) includes a plurality of separate converter fragments 510-1-510-N which can be selectively activated based on an operating parameter of the power converter circuitry 500 that is indicative of a load current requirement (i.e. a load current that the power converter circuitry is required to support).

The present disclosure also extends to a power converter system comprising a plurality of separate instances of power converter circuitry 500 coupled together to provide an output voltage VOUT to a load.

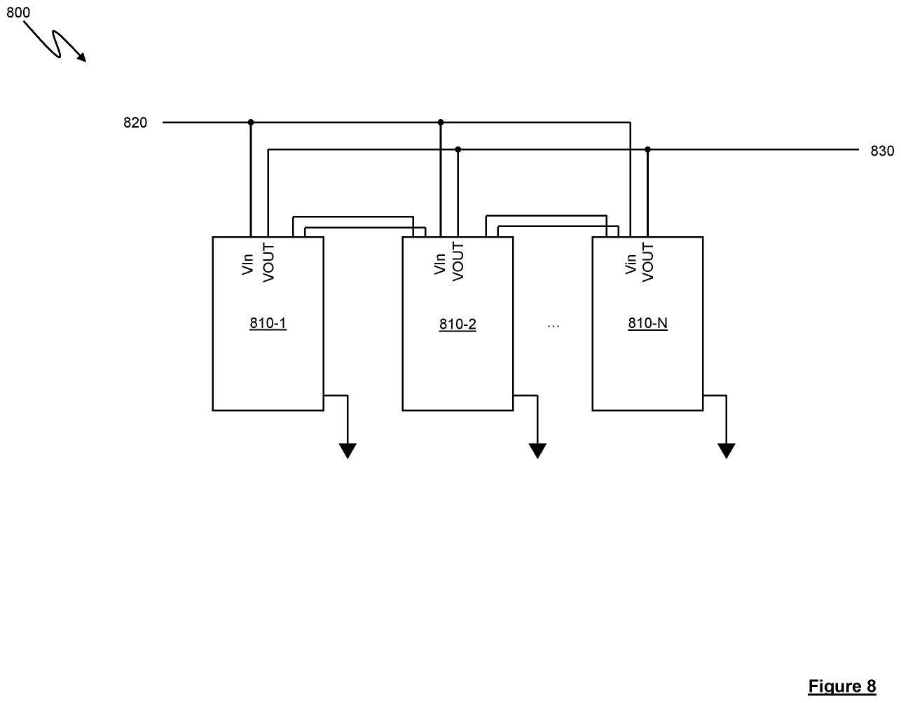

FIG. 8 is a diagrammatic representation of such a power converter system. The system, shown generally at 800 in FIG. 8, comprises a plurality (in this example three) of ICs 810-1-810-N implementing power converter circuitry of the kind described above with reference to FIG. 5. It will be appreciated by those of ordinary skill in the art that the power converter system 800 may include only two ICs, or may include more than three ICs.

An input voltage contact (e.g. ball, pad, pin etc.) of each IC 810-1-810-N is coupled to a supply voltage rail 820, and an output voltage contact (e.g. ball, pin, pad etc.) is coupled to an output voltage rail 830. A ground contact (e.g. ball, pad, pin etc.) of each IC 810-1-810-N is coupled to a ground (or other reference voltage) supply rail.

The ICs 810-1-810-N are coupled together in a daisy-chain configuration, with a first IC 810-1 being designated as a primary or controller IC and the other ICs 810-2-810-N being designated secondary ICs. The ICs 810-1-810-N communicate with each other using a communication protocol such that the primary or controller IC 810-1 can selectively activate and deactivate not only its own converter fragments, but also the converter fragments of the secondary ICs, according to an operating parameter (e.g. a switching frequency, input current, output current, output voltage or the like) of the power converter circuitry of the primary or controller IC 810-1.

To this end, control outputs of the controller 780 of the power converter circuitry 500 of the primary or controller IC 810-1 may be coupled to control inputs of the secondary ICs 810-1-810-N, (e.g. control inputs of the controller 780 or the clock generator circuitry 730 of the secondary ICs 810-1-810-N) such that the controller 780 of the primary or controller IC 810-1 is able to control operation of the converter fragments of the secondary ICs 810-1-810-N, to permit the system 800 to support a load current requirement.

In particular, the controller 780 of the primary or controller IC 810-1 can activate all the converter fragments of all the ICs 810-1-810-N in response to a step increase in load current, which may be detected, as described above, if the output voltage VOUT of the system 800 drops to (or below) the second threshold Th2. The controller 780 of the primary or controller IC 810-1 can also selectively activate and deactivate the converter fragments of all the ICs 810-1-810-N based on an operating parameter (e.g. switching frequency, input current, output current or output voltage) in the manner described above.

In another example of a power converter system, two or more ICs 810-1-810-N implementing power converter circuitry of the kind described above with reference to FIG. 5 may be coupled together as shown in FIG. 8, such that the ICs 810-1-810-N can communicate with each other using a communication protocol, but none of the ICs is designated as a primary or controller IC. Instead, each IC 810-1-810-N includes respective control circuitry (e.g. control circuitry 540 as described above with reference to FIG. 5) which is operable to control activation and deactivation of the converter fragments of its own IC 810-1-810-N (and in some examples the converter fragments of the other ICs 810-1-810-N) according to an operating parameter (e.g. a switching frequency, input current, output current, output voltage or the like) of the power converter system. Decentralising or distributing control of the converter fragments of the ICs 810-1-810-N in this way permits finer granularity in the control of the converter fragments to meet a load current requirement.

In the example described above with reference to FIG. 5, one instance of power converter circuitry 500 comprises three separate converter fragments 510-1-510-N. It will be appreciated by those of ordinary skill in the art that the power converter circuitry 500 could include more than three converter fragments. Increasing the number of converter fragments increases the granularity with which the output impedance of the power converter circuitry can be controlled, thus permitting finer control over the load current range that can be supported by the power converter circuitry, which may facilitate optimising or improving the efficiency of the power converter circuitry for a given load current requirement.

In some applications it may not be necessary for the power converter circuitry 500 to include three (or more) converter fragments, and so in such applications the power converter circuitry 500 may include only two converter fragments. In particular, where a plurality of ICs implementing power converter circuitry are coupled together to form a power converter system as described above with reference to FIG. 8, each IC could implement power converter circuitry having only two converter fragments, with the converter fragments of each IC being of different sizes, to enable the power converter system to support a desired load current range.

The power converter circuitry 500 of the present disclosure is described above as being particularly suited to use in the power conversion architecture of the host device 200 shown in FIG. 2, i.e. as a step-down converter to provide a reduced supply voltage. However, it will be appreciated that the power converter circuitry 500 could equally be used as a step-up converter, with a suitable control scheme for the switches 512-518 of each converter fragment 510-1-510-N.

Further, the power converter circuitry 500 is equally suited to forward power conversion applications (step-up or step-down), e.g. for supplying power from a battery or battery pack to one or more loads and reverse power conversion applications (step-up or step-down), e.g. for charging a battery or battery pack of a first device using electrical power received from a battery or battery pack of a second device or from another power source such as a battery charger.

As will be apparent from the foregoing discussion, the power converter circuitry of the present disclosure effectively balances the need for efficiency with the need to avoid switching frequencies in the audio band, thus permitting high efficiency across a desired load current range without generating audible noise.

In the examples described in the foregoing description the power converter circuitry 500 comprises switched-capacitor converter circuitry, but it will be appreciated by those of ordinary skill in the art that the principles of the present disclosure could equally be implemented using different power converter topologies, or using a mixture of different power converter topologies. For example, the plurality of converter fragments could be implemented as a plurality of separate parallel instances of inductive converter circuitry (e.g. buck converter circuitry) or as one or more instances of inductive converter circuitry coupled in parallel with one or more instances of capacitive converter circuitry, or as one or more instances of hybrid capacitive-inductive converter circuitry.

The circuitry described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications, embodiments will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. Switched capacitor power converter circuitry comprising:
a first converter fragment;
a second converter fragment; and
control circuitry, wherein the control circuitry is configured to selectively activate the second converter fragment based on an operating parameter indicative of a load current that the switched capacitor power converter circuitry is required to support.

2. Switched capacitor power converter circuitry according to claim 1, wherein each of the first converter fragment and the second converter fragment comprises:
a switch network comprising a plurality of switches;
first contacts for coupling the switch network to a flying capacitor; and
second contacts for coupling the switch network to an output capacitor of the switched capacitor power converter circuitry.

3. Switched capacitor power converter circuitry according to claim 2, wherein the operating parameter is a switching frequency of the switch network of the first converter fragment.

4. Switched capacitor power converter circuitry according to claim 3, wherein the control circuitry is configured to activate the second converter circuitry if the switching frequency is equal to or less than a first switching frequency threshold.

5. Switched capacitor power converter circuitry according to claim 4, wherein the first switching frequency threshold is configured to prevent switching of the switch network(s) at a switching frequency in the audio band.

6. Switched capacitor power converter circuitry according to claim 5, wherein the first switching frequency threshold is configured to maintain the switching frequency equal to or greater than 25 kHz.

7. Switched capacitor power converter circuitry according to claim 4, wherein the control circuitry is configured to deactivate the second converter circuitry if the switching frequency is equal to or greater than a second switching frequency threshold.

8. Switched capacitor power converter circuitry according to claim 7, wherein:
the first converter fragment is configured to receive a first clock signal for controlling a switching frequency of the switch network of the first converter fragment;
the second converter fragment is configured to receive a second clock signal for controlling a switching frequency of the switch network of the second converter fragment; and
the control circuitry is configured to disable the second clock signal to deactivate the second converter fragment and to enable the second clock signal to activate the second converter fragment.

9. Switched capacitor power converter circuitry according to claim 2, wherein the control circuitry is operative to control a switching frequency of the switch network of the first and/or the second converter fragment based on an output voltage of the power converter circuitry or a ratio of an input voltage to the output voltage of the power converter circuitry.

10. Switched capacitor power converter circuitry according to claim 9, wherein the control circuitry is operative to increase the switching frequency if the output voltage of the power converter circuitry meets a first predefined threshold.

11. Switched capacitor power converter circuitry according to claim 9, wherein the control circuitry is operative to activate the first converter fragment and the second converter fragment if the output voltage of the power converter circuitry meets or falls below a second predefined threshold.

12. Switched capacitor power converter circuitry according to claim 11, wherein the control circuitry is operative to deactivate the second converter fragment if the output voltage of the power converter subsequently exceeds the second predefined threshold and the switching frequency is equal to or less than a second switching frequency threshold.

13. Switched capacitor power converter circuitry according to claim 2, wherein the control circuitry is operable to adjust an effective on-resistance of one or more of the plurality of switches of the switch network of the first and/or second converter fragment.

14. Switched capacitor power converter circuitry according to claim 1, wherein the first converter fragment and the second converter fragment are coupled in parallel.

15. Switched capacitor power converter circuitry according to claim 1, wherein the first converter fragment and the second converter fragment have different switching frequency to output impedance characteristics.

16. Switched capacitor power converter circuitry according to claim 1, wherein the switched capacitor power converter circuitry implements a converter stage of a multi-stage power converter architecture.

17. An integrated circuit comprising switched capacitor power converter circuitry according to claim 1.

18. A host device comprising switched capacitor power converter circuitry according to claim 1.

19. A host device according to claim 18, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

20. Switched capacitor power converter circuitry comprising:
a plurality of converter fragments; and
control circuitry,
wherein a first converter fragment of the plurality of converter fragments is always active, and wherein the control circuitry is configured to selectively activate or deactivate the other converter fragments of the plurality of converter fragments based on a switching frequency of the first converter fragment.

21. Switched capacitor power converter circuitry for supplying a load, the switched capacitor power converter circuitry comprising a plurality of converter fragments and control circuitry, wherein the control circuitry is configured to activate all of the plurality of converter fragments in response to detection of a load step condition.

22. Switched capacitor power converter circuitry according to claim 21, wherein the control circuitry comprises comparator circuitry configured to compare an output voltage of the switched capacitor power converter circuitry to a load step voltage threshold and to output a signal indicative of detection of a load step condition if the output voltage is equal to or less than the load step threshold voltage.

23. Switched capacitor power converter circuitry comprising a plurality of converter fragments, each converter fragment having a different load current capacity for a given switching frequency, wherein the switched capacitor power converter circuitry is operable to activate one or more of the converter fragments based on a current demand of a load coupled to the switched capacitor power converter circuitry.

24. A power converter integrated circuit (IC), for providing a supply voltage to a load, the power converter IC comprising a plurality of separate switched capacitor power converter fragments, each switched capacitor power converter fragment comprising a switch network configured to be coupled to a respective flying capacitor and to a common output capacitor.

25. A power converter IC according to claim 24, further comprising control circuitry for controlling operation of the switch networks of the switched capacitor power converter fragments.

26. A power converter IC according to claim 25, wherein the control circuitry is configured to selectively activate one or more of the plurality of separate switched capacitor power converter fragments based on a switching frequency of an active power converter fragment of the plurality of separate switched capacitor power converter fragments.

27. A power converter IC according to claim 25, wherein the control circuitry is configured to activate all of the switched capacitor power converter fragments of the plurality of separate switched capacitor power converter fragments in response to a determination that an output voltage of the power converter IC is equal to or less than a load step threshold voltage.

28. A power converter system for providing a supply voltage to a load, the power converter system comprising:
a primary power converter IC comprising a first plurality of switched capacitor power converter fragments; and
a secondary power converter IC comprising a second plurality of switched capacitor power converter fragments, the secondary power converter IC being coupled to the primary power converter IC,
wherein the primary power converter IC is configured to control operation of the switched capacitor power converter fragments of the primary power converter IC and the secondary power converter IC.

29. A power converter system according to claim 28, wherein the primary power converter IC comprises control circuitry operable to selectively activate the switched capacitor converter fragments of the primary and secondary power converter ICs based on a switching frequency of an active switched capacitor converter fragment.

30. A power converter system according to claim 28, wherein the primary power converter IC comprises control circuitry operable to active all the switched capacitor converter fragments of the first power converter IC and the second power converter IC in response to a determination that an output voltage of the power converter system is equal to or less than a load step threshold voltage.

31. A power converter system for providing a supply voltage to a load, the power converter system comprising:
a first power converter IC comprising a first plurality of switched capacitor power converter fragments; and
a second power converter IC comprising a second plurality of switched capacitor power converter fragments, the second power converter IC being coupled to the first power converter IC,
control circuitry configured to control operation of the switched capacitor power converter fragments of the first power converter IC and the second power converter IC.

32. A power converter system according to claim 31, wherein the control circuitry is provided in the first and/or second power converter IC.

33. A power converter system comprising:
a first converter stage configured to receive a supply voltage and output an intermediate voltage; and
a second converter stage configured to receive the intermediate voltage and output a final supply voltage for supplying a load,
wherein the first converter stage or the second converter stage comprises:
switched capacitor converter circuitry comprising:
a first converter fragment;
a second converter fragment; and
control circuitry configured to selectively activate the first and second converter fragments based on an operating parameter indicative of a load current that the power converter system is required to support.
